(19) United States
(12) Patent Application Publication
(10) Pub. No.: US 2009/0253582 A1
(43) Pub. Date: Oct. 8, 2009

(54) CHAMBER APPARATUS

(75) Inventors: Solomon R. Pena, Gilbert,, AZ (US); Kevin M. Reinhart, Chandler, AZ (US); Roberta L. Druyor-Sanchez, Mesa, AZ (US); Noah Lermer, Chandler, AZ (US); Tamma Kaysser-Kranich, Phoenix, AZ (US)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 12/303,425

(22) PCT Filed: Jun. 27, 2007
(86) PCT No.: PCT/US07/72172

§ 371 Date: Dec. 22, 2008

Related U.S. Application Data
(60) Provisional application No. 60/806,108, filed on Jun. 29, 2006.

(51) Int. Cl. C40B 30/00; B01L 3/00; C40B 60/00; B23P 11/00

(52) U.S. Cl. 506/7; 422/102; 506/33; 29/428

(57) ABSTRACT

This invention provides a system that allows a user to assemble a chamber apparatus that prohibits samples from leaking or mixing with other samples or chamber array wells, when they are inserted into an array well of the chamber apparatus. In addition, the chamber frame design allows for easy assembly and disassembly for simplified use and slide substrate scanning on conventional microarray scanners. Chamber apparatus includes a chamber frame with an upper integrated gasket and a lower integrated gasket, a substrate, and a substrate frame that positions and captures the substrate. The lower integrated gasket provides a single sealing surface between the chamber frame and the substrate. The upper integrated gasket interfaces with a chamber cover forming a compression seal that prevents sample loss due to evaporation during the hybridization process. The chamber frame and substrate frame have integrated features that allow them to align and fasten to each other by latching or snapping resulting in an optimal clamping force to produce a compression seal between the integrated lower gasket and the substrate.

### CROSS-REFERENCE TO RELATED APPLICATIONS

This application claims priority to U.S. provisional patent application No. 60/806,108 filed Jun. 29, 2006; the disclosure of which is incorporated herein by reference in its entirety.

### FIELD OF THE INVENTION

This invention relates to a chamber apparatus.

### BACKGROUND OF THE INVENTION

In order to conduct parallel expression profiling of hundreds to thousands of genes or proteins typically a microarray is utilized. A microarray is a collection of microscopic spots attached to a substrate in a defined pattern, with the substrate generally consisting of a slide, chip, or plate of glass, plastic, or silicon. The spots may be of DNA, biological or chemical samples, other nucleic acids, proteins, or other probe materials. The probes are immobilized in a predetermined pattern on the substrate, such that each probe has a defined position. Microarray-based assays typically include exposing the arrayed probes to fluidic samples that contain target materials, which may interact with specific probes on the microarray. In a nucleic acid microarray, for example, arrayed single-stranded synthetic oligonucleotide or cDNA probes are contacted with labeled (e.g., fluorescently, radioactively, etc.) single-stranded target nucleic acids, which hybridize with complementary probe molecules in the microarray. Since the probes are arrayed at predetermined positions, the presence and quantity of target sequences in the fluid can be identified by the position at which fluorescence or radiation is detected and the intensity of the emitted fluorescence or radiation, respectively.

Microarray technology provides a user with the ability to perform hundreds to thousands of parallel biological or chemical assays. This technology is applicable for basic and applied research. For basic research, microarray based assays are used in finding genes (e.g. by hybridizing cDNA to predict open reading frames) and in the identification of common regulatory elements (e.g. by gene co-expression), for example. In applied research, the technology is used, e.g., in complex system profiling (e.g., of specific organs and diseases, stress responses, aging, and wound healing) in disease diagnosis, prognosis, and classification, in performing toxicity assessments (e.g., of drugs, foods, environmental conditions, etc.), and in drug discovery (e.g., to identify and validate targets to optimize efficacy, etc.)

Microarrays are typically manufactured by synthesizing or dispensing probe material on the surface of a planer substrate. To conduct an assay, a fluid well is typically formed by addition of chamber on the top surface of the substrate. Currently, this configuration of microarray or multiple well plate assays includes an assembly containing the array itself, with a chamber to contain the target hybridization solution, and a separate gasket or adhesive to contain the solution in the wells and prevent leakage. This type of plate or assay configuration requires multiple components to be assembled, very accurate gasket placement, and sufficient pressure to hold and compress the gasket to the substrate without buckling. The requirement for utilization of multiple components makes it cumbersome to fully utilize the microarray or multiple well plates. In addition, there is a risk of incorrect gasket placement such that when a sample is loaded into an array or well plate, this sample may leak into another array or well plate, which prevents an accurate test from being conducted. Further, as assays are often conducted over extended time periods or at elevated temperatures, the chambers must be sealed to prevent evaporation.

Therefore, there are several features of a chamber design that are desirable. The interface between the substrate and chamber must form a seal to prevent fluid from leaking out. The chamber must be critically aligned with the probe features on the substrate. The chamber/substrate apparatus should be easy to assemble. Further, the chamber should be removable, to allow the substrate to be scanned or imaged in standard equipment. It is also beneficial for the chamber to be designed for ease of use during the assay, either by manual handing of an operator, or by integration with standard automation equipment. To this end, the formation of a top chamber surface that may be easily sealed, either manually or by an automated system, is required. There are currently no microarray chamber designs available that incorporate all of these features. The current invention describes a chamber apparatus with an integrated lower gasket to form a removable seal to the substrate, and a second integrated upper gasket to form a sealable surface to enclose the chamber with a chamber cover, thereby limiting evaporation.

### BRIEF SUMMARY OF THE INVENTION

The present invention has been accomplished in view of the above-mentioned technical background, and it is an object of the present invention to provide a chamber apparatus that may contain a single well or multiple wells that prevents inserted samples from leaking into other portions or other wells of the chamber apparatus. It is an additional object of the present invention to provide a chamber apparatus that is easily utilized and assembled, and also easily disassembled for further substrate processing.

In a preferred embodiment of the invention, a chamber apparatus is disclosed. A chamber frame has an integrated upper gasket and an integrated lower gasket, where a cover is disposed over the integrated upper gasket. The integrated upper gasket and the integrated lower gasket are disposed on the chamber frame by over-molding. A substrate is disposed below the chamber frame, where the substrate interfaces with the integrated lower gasket. A substrate frame is disposed below the substrate, where the substrate frame structure is configured to receive the substrate, where the substrate frame is aligned and fastened to the chamber frame that is configured to receive the substrate frame. A chamber cover is disposed onto the integrated upper gasket forming a leak tight seal and preventing evaporation of the assay fluid. The chamber cover may cover one or multiple chamber apparatuses, and may be placed or removed manually or by automation hardware.

In another preferred embodiment of the invention, a system for utilizing multiple chamber apparatuses is disclosed. A plurality of chamber apparatuses is inserted into chamber tray. The chamber tray is configured to receive the plurality of chamber apparatuses.

In yet another preferred embodiment of the invention, a method of assembling a chamber apparatus is disclosed. A chamber frame is provided. The chamber frame is disposed in between an integrated upper gasket and an integrated lower gasket by over-molding. A substrate frame and substrate are provided. A cover over the integrated upper gasket is provided. The substrate frame positions and contains the substrate. A chamber frame is placed over the substrate and substrate frame. The chamber frame is assembled into the substrate frame producing a leak tight seal between the substrate and individual well(s).

### BRIEF DESCRIPTION OF THE DRAWINGS

These and other advantages of the present invention will become more apparent as the following description is read in conjunction with the accompanying drawings, wherein:

FIG. 1 illustrates a chamber apparatus in accordance with an embodiment of the invention;

FIG. 2 illustrates the chamber apparatus of FIG. 1 with a multi-well format in accordance with the invention;

FIG. 3 illustrates a bottom exploded view of the chamber apparatus of FIG. 1 in accordance with the invention;

FIG. 4 illustrates a slide rail of the chamber apparatus of FIG. 1 in accordance with the invention;

FIG. 5 illustrates a tooling structure of the chamber apparatus of FIG. 1 in accordance with the invention;

FIG. 6 illustrates multiple chamber apparatuses being inserted into a chamber tray in accordance with the invention;

FIG. 7 depicts a flow chart of how the chamber apparatus of FIG. 1 is assembled in accordance with the invention; and

FIG. 8 depicts a flow chart that shows an example of how the chamber apparatus of FIG. 1 is utilized in a hybridization process.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

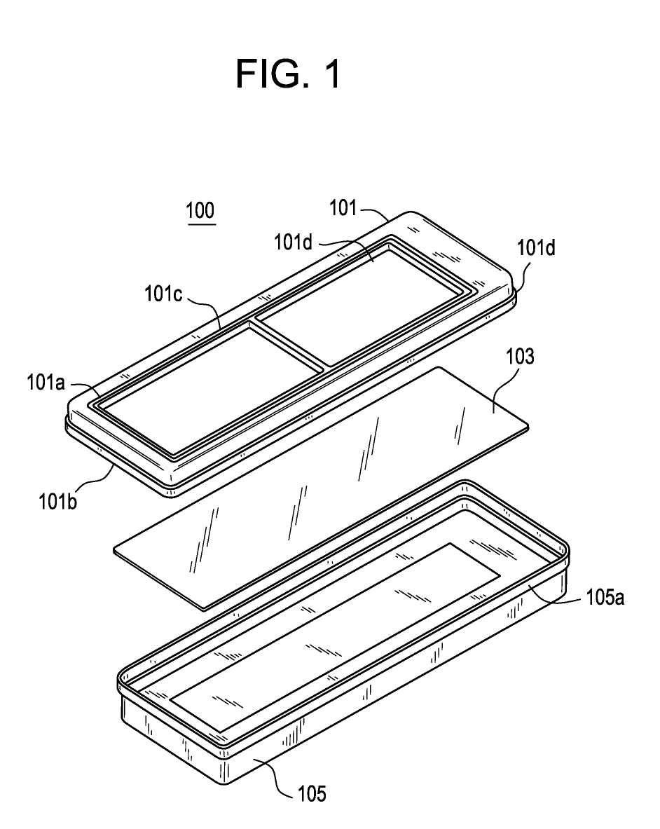

FIG. 1 illustrates a chamber apparatus. The chamber apparatus 100 includes a chamber frame 101, a substrate 103 and a substrate frame 105. The chamber frame 101 may be referred to as a chamber or frame. Chamber frame 101 and substrate frame 105 may be made of plastic, polypropylene, polycarbonate, polystyrene or any material known to those of ordinary skill in the art. Chamber frame 101 includes an integrated upper gasket 101a located in a middle of an upper portion of chamber frame 101 and an integrated lower gasket 101b located in a middle of a lower portion of the chamber frame 101. Chamber frame 101 is disposed between the upper integrated gasket 101a and the lower integrated gasket 101b by a typical machine injection molding, two-shot injection molding, or over-molding process known to those of ordinary skill in the art. Thus, the upper integrated gasket 101a and the lower integrated gasket 101b are over-molded to the chamber frame 101. For co-injection molding or “sandwich” molding, this process requires the injection of a skin to partially fill a cavity, followed by the core component to pack out the part. This process can use two injection units and rotary molds designed for sequential injection, or a robot transferred mold.

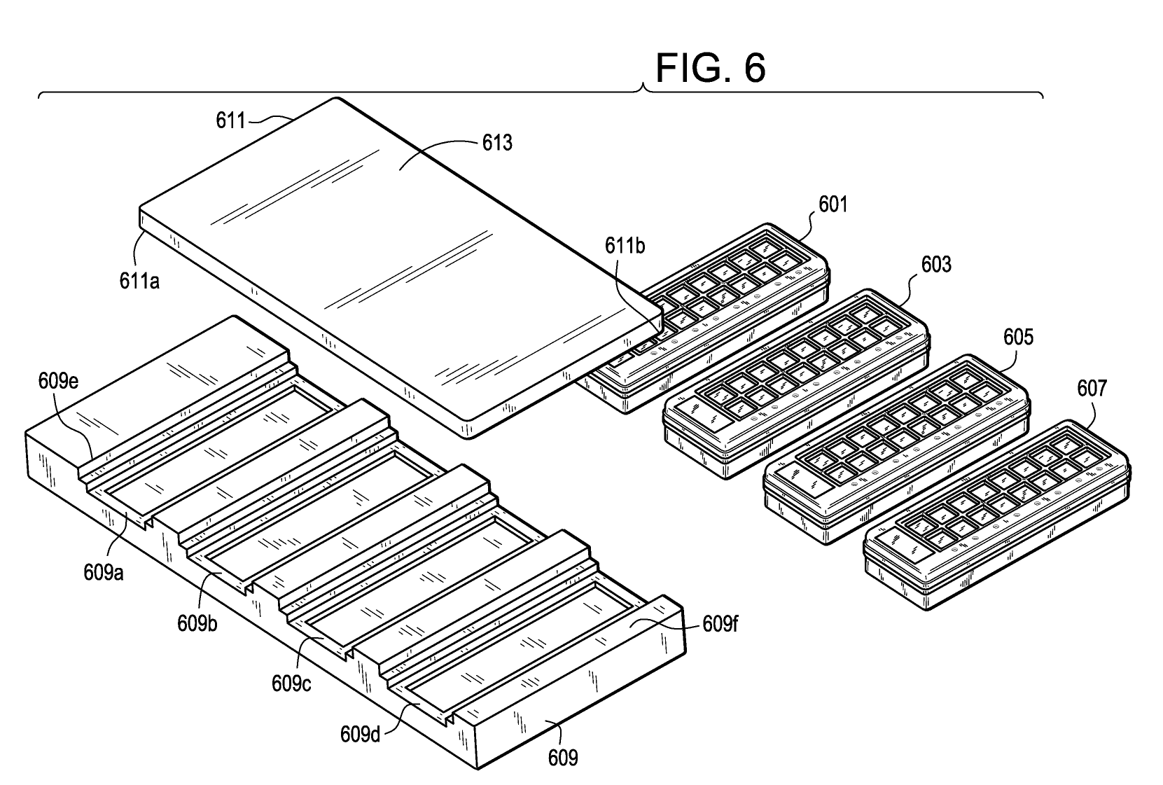

The lower exterior portion of the frame 101 also includes a slide rail 101d that acts as a means to locate and for fixturing or fitting the chamber apparatus 100 with the chamber tray 609 for automation, etc as in FIG. 6. A cover 101c may be referred as a chamber cover. Cover 101c may be made of the materials; polypropylene, polystyrene, thermoplastic elastomer or any number of plastics, steel aluminum and any other plate materials known to those of ordinary skill in the art.

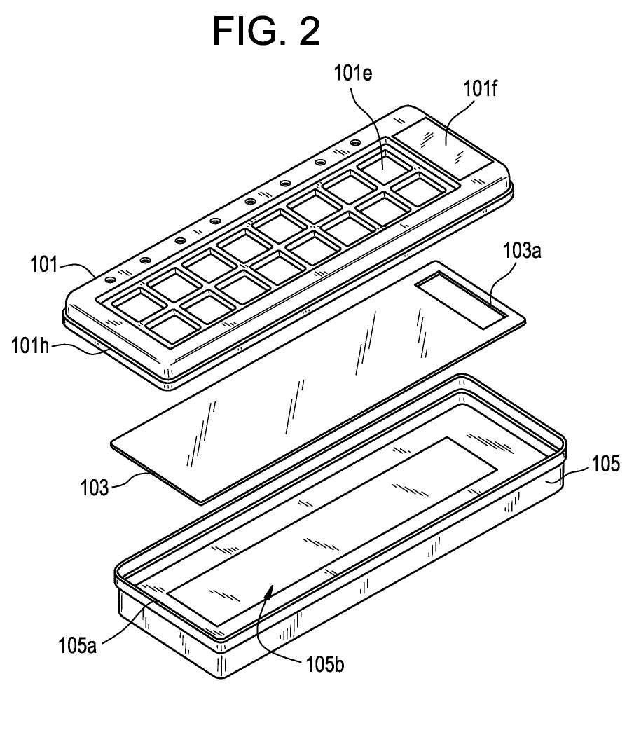

Chamber cover 101c is fabricated or produced by ordinary machining or machine injection molding processes. The chamber cover 101c is fabricated by using a molding or a machining process and it is disposed or assembled to 101 by snapping it in place manually. Critical variables such as draft and mold temperatures must be considered when utilizing this molding process. The cover or chamber cover 101c is utilized for hybridization to prevent evaporation by forming a compression seal with the upper integrated gasket. The lower integrated gasket, 101b, seal prevents samples, specimens or biomolecules (nucleic acids, proteins etc.) from leaking into other wells after the specimen is inserted into a well or chamber 101e (FIG. 2) of chamber frame 101. Each of the wells represented by 101e contains an array on the substrate when chamber assembly is formed. In another embodiment of the invention, the chamber frame may have multiple array wells that include, for example 2-array, 4-array, 6-array, 8-array, 10-array, 12-array wells or as many possible arrays on the substrate 103.

Referring to FIG. 2, in another embodiment an upper portion of the chamber frame 101 has an open well format with multiple wells denoted as 101e) on an 8.6 mm row×9 mm column pitch produced in a 16 up format, but it may also have 1, 2, 6 and 8 well format. The reduced row pitch from the standard SBS 9 mm×9 mm format, allows room for a label/barcode 101f to be placed on the chamber frame 101 and a label/barcode 103a on the substrate 103. Even though, this chamber frame 101 has an open well format of 8.6 mm row×9 mm column, the open well format may have any length and width dimensions applicable to the chamber apparatus 100 in the range of 1-30 mm length and width in the range of 1-50 mm, preferably the width is 25 mm. Also, the chamber frame 101 may use the standard pitch between wells of 4.5 mm, 9 mm, 2.25 mm and all the standard wells and standard pitches known to those of ordinary skill in the art.

These barcode labels 101f and 103a can be read by a wide range of commercial optical scanners. As an alternative, the labels may include an RFID tag or transponder, which can be read by scanners that utilize radio frequency identification (RFID) technology.

In FIG. 1, substrate 103 will be utilized to retain biological materials, such as DNA that will be inserted into the chamber apparatus 100. The dimensions of the substrate 103 correspond to the dimensions of the inside portion of the chamber frame 101 and the upper portion of the substrate frame 105. The substrate 103 may be made of the following materials: polypropylene, polyethylene, glass, silicone or any standard substrate material known to those of ordinary skill in the art and any of these substrates may be coated with a 2-dimensional or 3-dimensional layer. In another embodiment of this invention, the substrate 103 consists of a plurality of in the range of 2-100 substrate frames or more. Substrate frame 105 is disposed below the substrate 103.

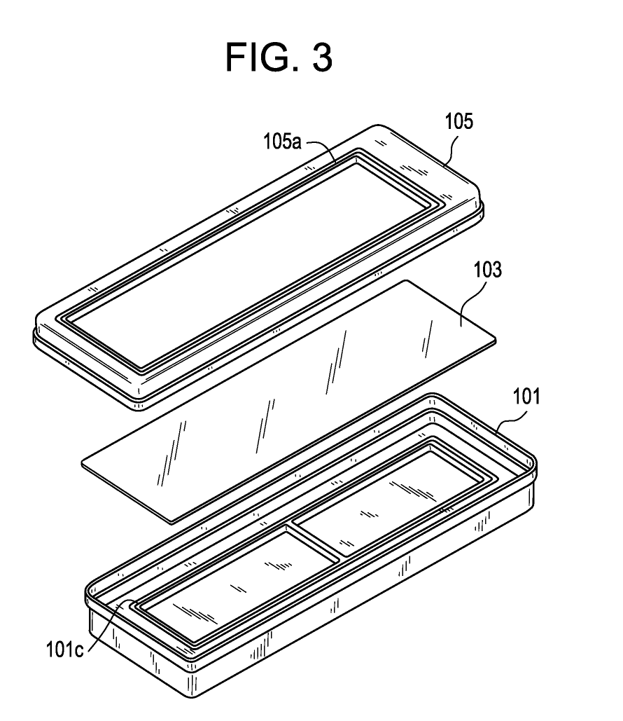

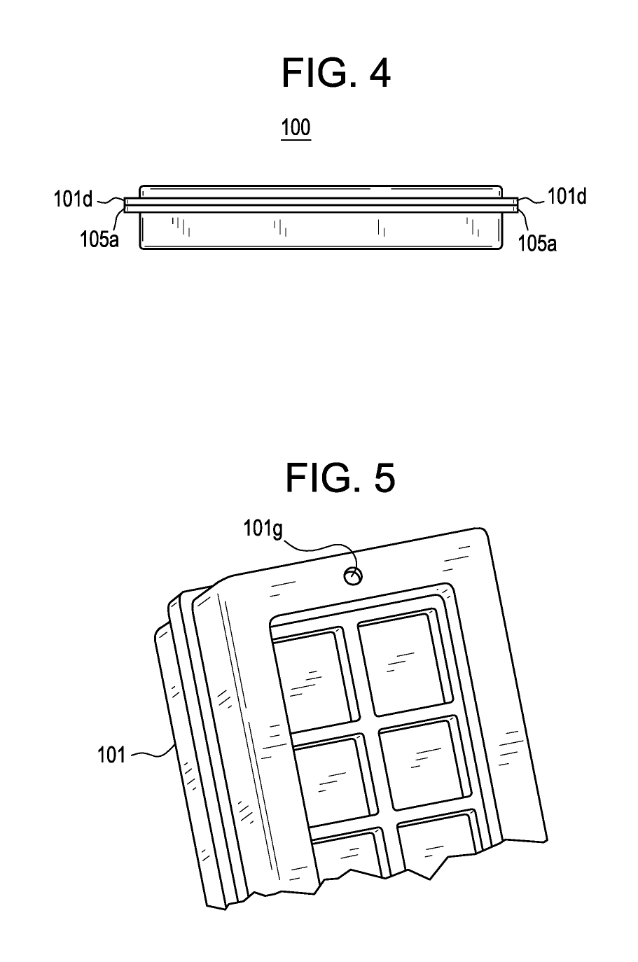

In FIG. 2, this substrate frame 105 includes a flat portion 105b that is capable of receiving the substrate 103 and positioning it in the substrate frame 105 for ease of assembly. When the chamber frame 101 is placed on top of the substrate 103, the bottom portion 101h (FIG. 3) of the chamber frame 101 receives the top portion of the substrate 103. As the chamber frame 101 receives the top portion of the substrate 103, the substrate frame 105 is disposed below, and around the substrate 103. Referring to FIG. 4, the chamber frame 101 is fitted into or snaps together with an outside portion 105a of the substrate frame 105, which compresses the integrated lower gasket 101b onto the top portion of the substrate 103 to form a leak tight seal between the integrated lower gasket 101b and the substrate 103. In another embodiment of the invention, chamber frame 101 compresses the integrated lower gasket 101b onto the top portion of substrate 103 by attaching to the upper portion 105a of the substrate frame 105 by utilizing integrated snaps or latches that will provide an optimal clamping force between the chamber frame 101 and the substrate frame 105 to produce an effective seal between the substrate 103 and the integrated lower gasket 101b interface.

Referring to FIG. 5, chamber frame 101 includes tooling holes (one on each end) 101g that are used for positioning the chamber apparatus 100 with an exterior fixture or feature in a chamber tray or any outside component. FIG. 6 shows multiple chamber apparatuses being inserted into a chamber tray. Multiple chamber apparatuses 601, 603, 605 and 607 are equivalent to the chamber apparatus 100 described above so a description of these apparatuses will not be included herein. A chamber tray 609 has four slide openings 609a, 609b, 609c and 609d. Each of the slide openings 609a, 609b, 609c and 609d are dimensioned and configured to receive a chamber apparatus by sliding the chamber apparatus into the slide opening. The chamber tray 609 may also be referred to as a slide holder. The chamber tray 609 and chamber cover 611 may be made from materials, such as acetal, polypropylene, PTFE, aluminum, stainless steel, polystyrene, acrylics or any standard chamber tray materials known to those of ordinary skill in the art. A chamber cover 611 is disposed over the chamber tray 609 and chamber apparatuses 601, 603, 605 and 607. A bottom portion 613 of the chamber cover 611 includes protrusions 611a and 611b that allows the chamber cover to fit in receiving portions 609e and 609f on a top portion of the chamber tray 609. This chamber cover 611 may be utilized to seal the chamber apparatuses 601, 603, 605 and 607, forming a seal with the upper gaskets 101a, while these chamber apparatuses undergo a hybridization process. Also, the chamber cover 611 may or may not be made of the same materials as chamber frame 101. In another embodiment of the invention, the chamber apparatuses 601, 603, 605 and 607 may include multiple array, similarly to chamber apparatus 100, for example 2-array, 4-array, 6-array, 8-array, 10-array, 12-array and the like. The multiple arrays may be used in place of single array throughout this description. Thus, when the multiple chamber apparatuses 601, 603, 605, 607 or 101 are undergoing an automation process or any process during an assay the multiple arrays may be used in place of a single array.

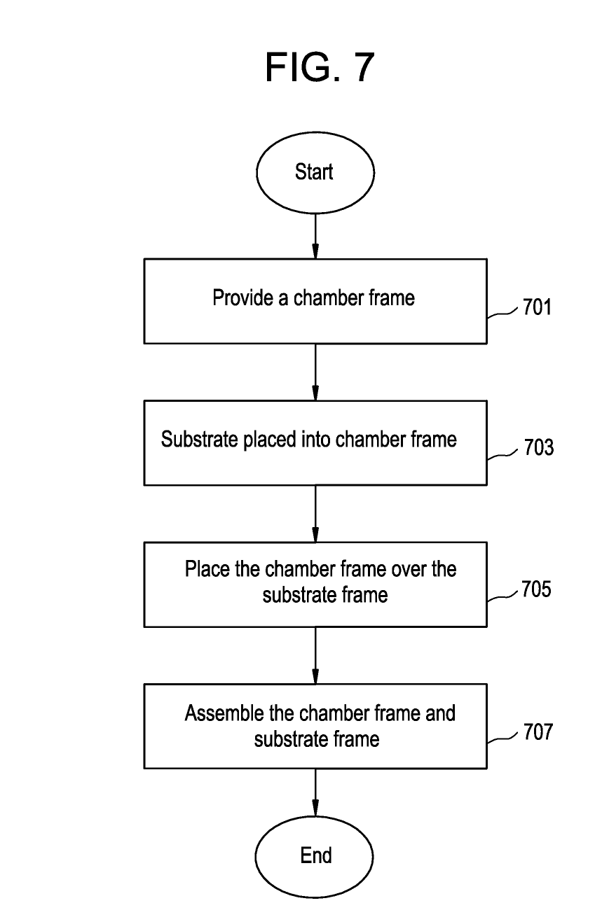

FIG. 7 depicts a flow chart of how the chamber apparatus 100 is assembled. At block 701, the substrate frame 105 is provided. This substrate frame 105, as stated above includes features to position and capture the substrate 103. At block 703, the substrate 103 is placed into the substrate frame 105. At block 705, the chamber frame 101 is placed over the substrate frame 105, which contains the substrate 103. Next, at block 707 the chamber frame and substrate frame are assembled by engaging the snaps or latches and the integrated lower gasket 101b is compressed against the substrate 103 to form a leak tight seal. The process ends and the chamber apparatus 100 (FIG. 1) is assembled.

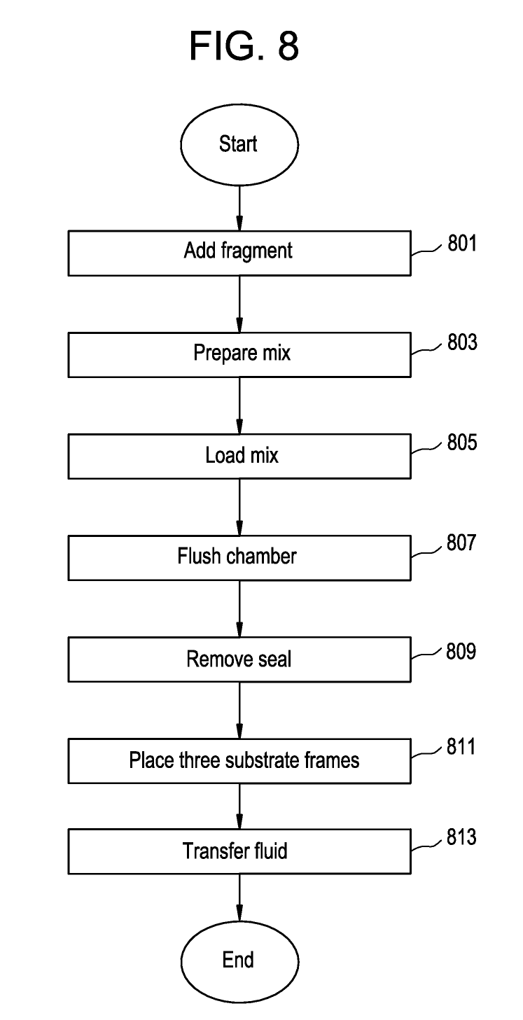

FIG. 8 depicts a flow chart that shows an example of how the chamber apparatus 100 is utilized in a hybridization process. At block 801, cRNA is added to a fragmentation buffer and incubated at 94 degrees Celsius for 5 minutes to 1 hour. Preferably, cRNA is incubated for 20 minutes. At block 803, a hybridization mix is prepared where cRNA is mixed with hybridization Buffer A and hybridization Buffer B in the container. Hybridization Buffer A and hybridization Buffer B are common microarray buffers known to those of ordinary skill in the art. At block 805, hybridization mixture is loaded into each array well 101e in the chamber apparatus 100 by a pipette or by any device capable of transferring liquid from one device to another. Next chamber cover 101c is placed over a top portion of the chamber apparatus 100 sealing the chamber array wells 101e. The chamber apparatus 100 is then placed in an incubator at a temperature of 37 degrees Celsius for a sufficient period of time to enable hybridization to occur.

Next, at block 807 the seal is removed and the well 101e of the chamber apparatus 100 is flushed and another solution is added to well 101e. For example, the well 101e is flushed three times with 0.75×TNT and 250 ul of 0.75×TNT is added into the well 101e and the well 101e is sealed again. The chamber apparatus 100 is incubated at 46 degrees Celsius for 1 hour. At block 809, the seal is removed from the well 101e and the solution is removed from the well 101e. Next, 250 ul of staining solution is then added, then the solution is incubated at ambient temperature for 30 minutes in a dark area. At block 811, the array well 101e is flushed three times, then 1×TNT is added in each well 101e and incubated at an ambient temperature for twenty minutes in a dark area. Next the 1×TNT is removed and the wells filled with a low salt final rinse buffer. At block 813 the final rinse solution is removed and the substrate is dried, by placing a chamber tray with the chamber apparatus into a centrifuge bucket and spinning until dry. The chamber apparatus 100 is placed in a light-tight box until scanning. The chamber apparatus may be dissembled to allow removal of the substrate 103, which may then be scanned by a suitable scanning or imaging device.

This invention provides a system that allows a user to assemble a chamber apparatus that prohibits samples from leaking or mixing with other samples or chamber array wells, when they are inserted into an array well of the chamber apparatus. In addition, the chamber frame design allows for easy assembly and disassembly for simplified use and slide substrate scanning on conventional microarray scanners. Chamber apparatus includes a chamber frame with an upper integrated gasket and a lower integrated gasket, a substrate, and a substrate frame that positions and captures the substrate. The lower integrated gasket provides a single sealing surface between the chamber frame and the substrate. The upper integrated gasket interfaces with a chamber cover forming a compression seal that prevents sample loss due to evaporation during the hybridization process. The chamber frame and substrate frame have integrated features that allow them to align and fasten to each other by latching or snapping, resulting in an optimal clamping force to produce a compression seal between the integrated lower gasket and the substrate.

It is intended that the foregoing detailed description of the invention be regarded as illustrative rather than limiting and that it be understood that it is the following claims, including all equivalents, which are intended to define the scope of the invention.

What is claimed is:

1. A chamber apparatus, comprising:
a chamber frame having an integrated upper gasket and an integrated lower gasket, wherein a cover is disposed over the integrated upper gasket;
wherein the integrated upper gasket and the integrated lower gasket are disposed on the chamber frame by overmolding;
a substrate disposed below the chamber frame, wherein the substrate interfaces with the integrated lower gasket; and
a substrate frame disposed below the substrate, wherein the substrate frame structure is configured to receive the substrate, wherein the substrate frame is aligned and fastened to the chamber frame.

2. The apparatus of claim 1, wherein the chamber frame includes an integrated slide rail.

3. The apparatus of claim 2, wherein the cover is a chamber cover.

4. The apparatus of claim 3, wherein the cover is made from the material comprising polypropylene, polystyrene, thermoplastic elastomer, steel or aluminum.

5. The apparatus of claim 1, wherein the integrated upper gasket and integrated lower gasket are overmolded onto the chamber frame by a two-shot molding process.

6. The apparatus of claim 1, wherein the integrated upper gasket and integrated lower gasket are overmolded onto the chamber frame by a co-injection molding process.

7. The apparatus of claim 1, wherein the substrate is made from glass.

8. The apparatus of claim 1, wherein the substrate is made from a high temperature polyester.

9. The apparatus of claim 1, wherein the substrate is made from a polyethylene.

10. The apparatus of claim 1, wherein the substrate contains a 2-dimensional or 3-dimensional coating.

11. The apparatus of claim 2, wherein the chamber frame integrated slide rail and the substrate frame are configured to be fitted into each other.

12. The apparatus of claim 11, wherein the integrated lower gasket is configured to be compressed into the substrate.

13. The apparatus of claim 12, wherein the chamber frame integrated slide rail fits into the substrate frame by snapping the chamber frame integrated slide rail into the substrate frame.

14. The apparatus of claim 1, wherein the chamber frame includes a multiple well format.

15. The apparatus of claim 1, wherein the chamber frame includes multiple array wells.

16. The apparatus of claim 15, wherein the multiple array wells comprise two, four, six, eight, twelve, or sixteen array wells.

17. A system for utilizing multiple chamber apparatuses, comprising:
a plurality of chamber apparatuses of claim 1;
the plurality of chamber apparatuses are inserted into a chamber tray; and
the chamber tray is configured to receive the plurality of chamber apparatuses.

18. The system of claim 17, wherein the chamber tray is a slide holder.

19. The system of claim 17, wherein the chamber tray includes a plurality of slide openings to receive the plurality of chamber apparatuses.

20. The system of claim 17, wherein the plurality of chambers includes a plurality of chamber frames.

21. The system of claim 20, wherein the plurality of chamber frames are made from the materials comprising acetal, polypropylene, PTFE, aluminum, stainless steel, polystyrene or acrylics.

22. The system of claim 17, further comprising a chamber cover disposed over the chamber tray and the plurality of chamber apparatuses.

23. The system of claim 22, wherein the chamber cover is configured to seal the plurality of chamber apparatuses, wherein the plurality of chamber apparatuses is configured to undergo a hybridization process.

24. A method of assembling a chamber apparatus, comprising:
providing a substrate frame, wherein the substrate frame contains features to position and capture a substrate;
placing the substrate into the substrate frame;
placing a chamber frame over the substrate;
wherein the chamber frame includes an integrated upper gasket and an integrated lower gasket;
engaging the snaps or latches of the chamber frame and the substrate frame such that the integrated lower gasket is pressed against the integrated lower gasket to form a leak tight seal;
providing a chamber cover over the integrated upper gasket on the chamber frame to provide a tight seal during array well processing;
placing the chamber frame and the substrate over the substrate frame; and
assembling the chamber frame into the substrate frame.

25. The method of claim 24, wherein the chamber frame integrated slide rail is placed into the substrate frame.

26. The method of claim 24, wherein the substrate is made of glass.

27. A method for utilizing a chamber apparatus comprising:
loading a solution into chamber array wells of the chamber apparatus in claim 1;
providing a chamber cover over the chamber apparatus to seal chamber array wells;
incubating said chamber apparatus under appropriate conditions;
flushing the chamber apparatus;
labeling the reactants on the substrate as required for detection; and
determining an amount of a reactant on each chamber array well area on the substrate.

28. The method of claim 27, wherein the substrate comprises a microarray format containing one or multiple array wells.

29. The method of claim 28, further comprising:
loading a hybridization solution into the chamber array well of the chamber apparatus;
providing a chamber cover over the chamber apparatus to seal the chamber array well;
incubating said chamber apparatus under appropriate conditions;
flushing the chamber apparatus;
labeling the reactants on the substrate with fluorescent molecules for detection;
determining the amount of reactant by scanning each chamber array well area on the substrate; and
quantitating each micro array spot the chamber apparatus to calculate level or reactant in the chamber array well.
